(19) United States
(12) Patent Application Publication
(10) Pub. No.: US 2008/0120897 A1
(43) Pub. Date: May 29, 2008

(54) Portable device for swatting and collecting bugs

(76) Inventors: James H. Miller, Morongo Valley, CA (US); Patricia Miller, Morongo Valley, CA (US)

Correspondence Address: T.L. GARRETT, PLC, P.O. BOX 1065, FENTON, MI, 48430, US

(21) Appl. No.: 11/605,682

(22) Filed: Nov. 29, 2006

(51) Int. Cl. A01M 3/02; A01M 1/06

(52) U.S. Cl. 43/137; 43/139

(57) ABSTRACT

A portable device for swatting and collecting bugs, insects, flies and the like is disclosed herein. In one practicable embodiment, the device includes a spread structure having a designated swatting surface, a handle having an inner hollow defined therein, a hollow tube having an open distal end joined to the spread structure and an open proximal end joined to the handle, an activatable vacuum system in fluid communication with the inner hollow of the handle, an electric power source electrically connected to the vacuum system, and a hold in fluid communication with the inner hollow of the handle. In this configuration, bugs can be struck with the swatting surface of the spread structure by wielding the handle, and air can be drawn into the open distal end of the hollow tube by activating the vacuum system so as to convey the bugs to the hold.

### FIELD OF THE INVENTION

The present invention generally relates to flyswatters. The present invention more particularly relates to devices for collecting bugs, insects, flies, and the like for disposal.

### BACKGROUND OF THE INVENTION

When using a conventional flyswatter to swat flies or insects, one often has to clean up the squashed remains of the insects from surfaces against which the insects were struck. Having to engage in such insect clean-up after using such flyswatters, however, is often highly undesirable. In particular, in addition to the inconvenience of having to subsequently wipe up insect remains from surfaces with a tissue or piece of paper, one often has to also remove the stain of insect residue from the surfaces as well. Removal of such staining can be toilsome, for it may require one or more subsequent applications of cleaning substances or even new coats of paint. Furthermore, if insect remains are particularly wiped from surfaces such as kitchen countertops or dining room tables, one must then apply disinfectant or cleansers to such surfaces as well so as to keep the surfaces sanitary in the interest of health.

In view of the above, there is a present need in the art for an insect-swatting implement or device that makes the subsequent collection and disposal of insect remains easier and less messy.

### SUMMARY OF THE INVENTION

The present invention provides a portable device for swatting and collecting bugs, insects, flies, and the like. In one practicable embodiment, the portable device includes a spread structure, a handle, a hollow tube, an activatable vacuum system, a hold, and an electric power source. The spread structure has a designated swatting surface, and the handle has an inner hollow defined therein. The hollow tube has an open distal end joined to the spread structure and also an open proximal end joined to the handle. Joined as such, the hollow tube thereby establishes fluid communication between the swatting surface of the spread structure and the inner hollow of the handle. Both the vacuum system and the hold are in fluid communication with the inner hollow of the handle, and the electric power source is electrically connected to the vacuum system. In this configuration, bugs can be struck with the swatting surface of the spread structure by wielding the handle, and air can be drawn into the open distal end of the hollow tube by activating the vacuum system so as to convey the bugs to the hold.

Furthermore, it is believed that various alternative embodiments of the present invention will become apparent to those skilled in the art when the detailed description of the best mode(s) contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a perspective view of a portable device utile for swatting and collecting bugs, insects, flies, and the like.

FIG. 2 illustrates a front view of the portable device depicted in FIG. 1.

FIG. 3 illustrates a side view of the portable device depicted in FIG. 1.

FIG. 4 illustrates a partial, sectional view of the portable device depicted in FIG. 1.

FIG. 5 illustrates a partial, sectional top view of the portable device depicted in FIG. 2.

FIG. 6 illustrates a perspective view of the portable device depicted in FIG. 1. In this view, the device is wielded in a human hand.

### LIST OF PARTS AND FEATURES

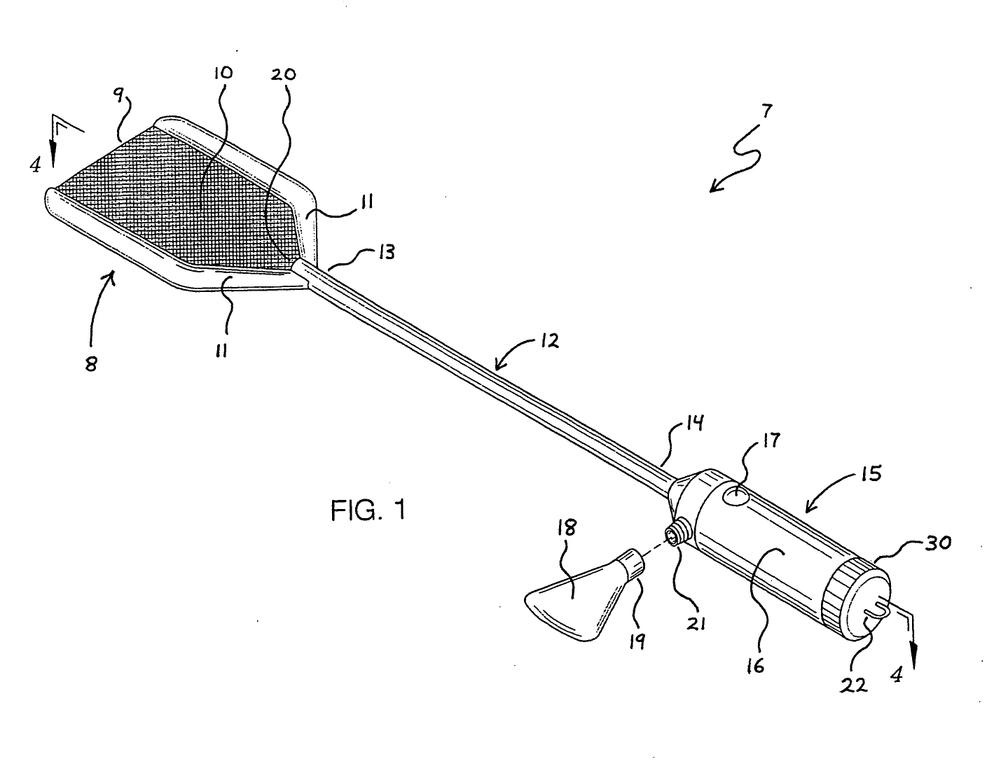

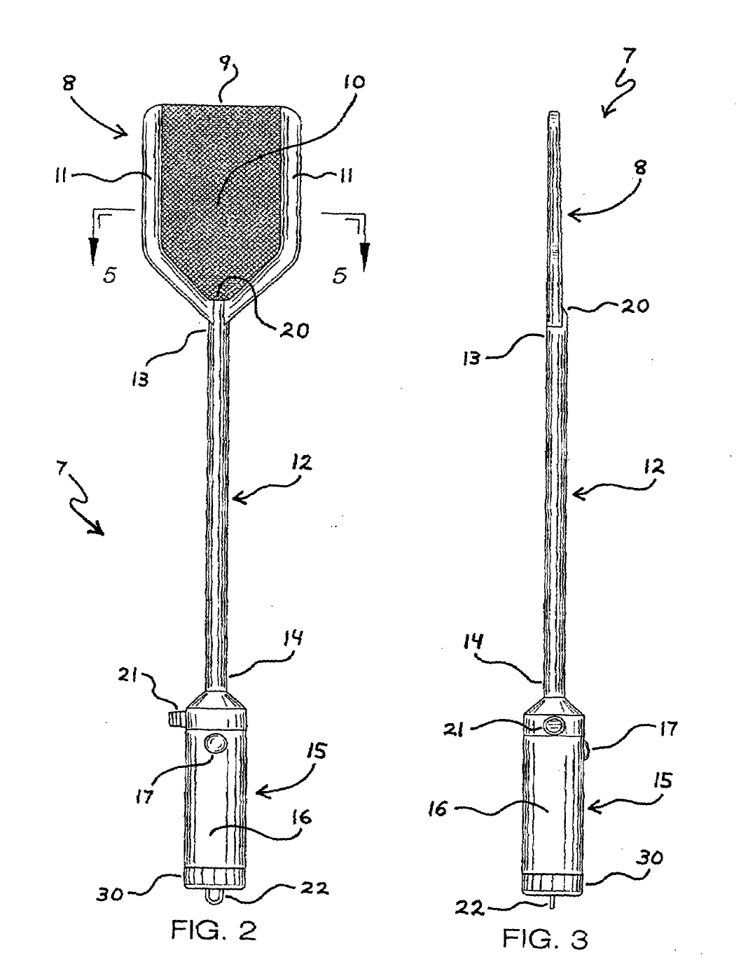

To facilitate a proper understanding of the present invention, a list of parts and features highlighted with alphanumeric designations in FIGS. 1 through 6 is set forth hereinbelow.
7 portable device (adapted for swatting and collecting bugs)
8 spread structure
9 mesh (made of, for example, metal wire or perforated plastic)
10 designated swatting surface (of spread structure)
11 raised padding (made of, for example, rubber or plastic)
12 hollow tube (made of resilient material such as, for example, plastic)
13 distal end (of hollow tube)
14 proximal end (of hollow tube)
15 wieldable handle (sized for a human hand)
16 outer surface (of handle)
17 manipulable on/off control (for example, a pressable button)
18 hold (for example, a bag)
19 fastener (or connector)
20 intake (of vacuum tube)
21 evacuation or exhaust port (on outer surface of handle)
22 suspension hook or loop (on end cap of handle)
23 pliable bag (permeable by air)
24 collection area (for bugs)
25 conduit (defined in hollow tube)
26 rotatable fan (for creating a vacuum)
27 activatable electric motor (for rotating the fan)
28 electrical control circuitry (for switching the motor on/off)
29A battery (electric power source for motor)
29B battery (electric power source for motor)
29C battery (electric power source for motor)
30 removable end cap (of handle)
31 wishbone frame (for suspending the mesh)
32 inner hollow (of handle)

### DETAILED DESCRIPTION OF THE INVENTION

FIGS. 1 through 6 illustrate various views of one practicable embodiment of a portable device 7 pursuant to the present invention. As shown in these views, the portable device 7 includes a spread structure 8, a handle 15, a hollow tube 12, an activatable vacuum system, an electric power source, and a hold 18. During operation, the portable device 7 is useful for swatting and collecting bugs, insects, flies, and the like.

As best shown in FIGS. 1, 2, 4, and 5, the spread structure 8 includes a mesh 9, a wishbone-shaped frame 31, and raised padding 11. The mesh 9 is suspended within the frame 31 so as to form a substantially planar surface 10 on the spread structure 8, which is preferably designated for swatting bugs. The raised padding 11 is included on the spread structure 8 at the periphery of the swatting surface 10. The mesh 9 itself may be made of, for example, metal wire or perforated plastic. So as to be flexible, the frame 31 is preferably made of a resilient material such as, for example, plastic. The raised padding 11 is preferably made of plastic, rubber, or some other material that is somewhat both flexible and cushiony.

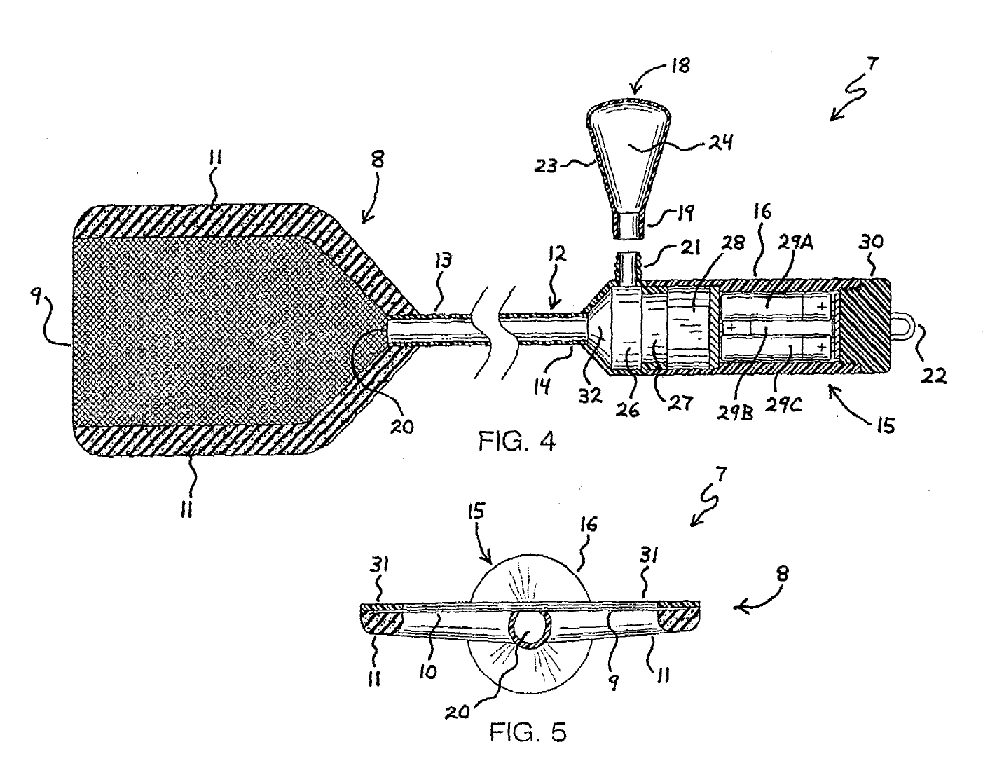

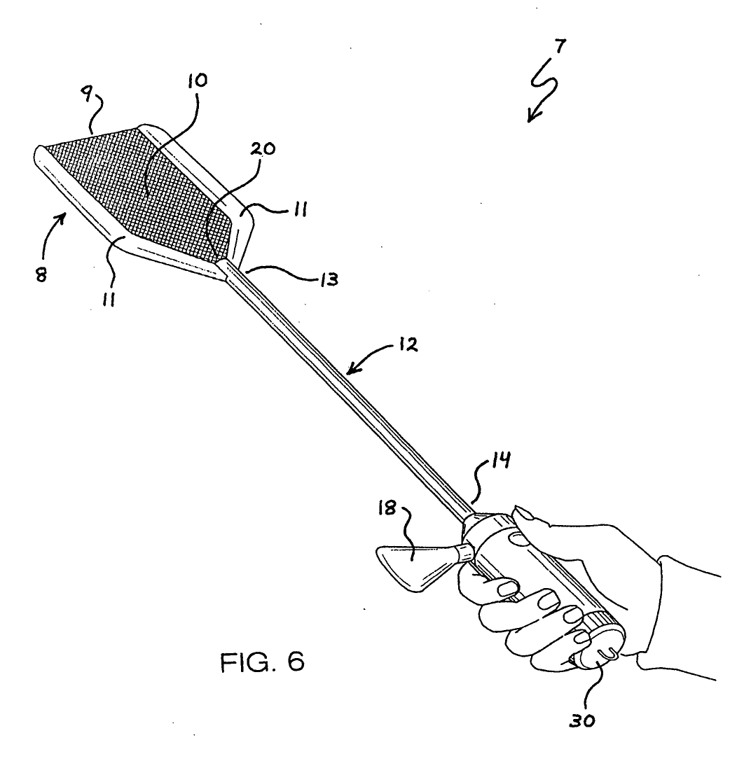

As shown in FIGS. 1 and 4, the handle 15 has an outer surface 16 and an inner hollow 32 defined therein. To be easily wieldable, the handle 15 is preferably sized so as to be portable in a single human hand, as shown in FIG. 6. For purposes of safety, the handle 15 itself is preferably made of hard plastic or some other material that is both electrically insulative and substantially shatterproof. To facilitate hanging up the portable device 7 in between uses, the handle 15 has a suspension hook or loop 22 on its outer surface 16.

As further shown in FIGS. 1 through 5, the hollow tube 12 is substantially cylindrical and has both a distal end 13 joined to the spread structure 8 and a proximal end 14 joined to the handle 15. The tube's distal end 13 is generally open and thereby defines an intake 20, and the tube's proximal end 14 generally opens into the handle's inner hollow 32. Joined as such, the hollow tube 12 thereby establishes fluid communication between the swatting surface 10 of the spread structure 8 and the inner hollow 32 of the handle 15 via an inner conduit 25 defined along its length. So as to be flexible, the hollow tube 12 itself is preferably made of a resilient material such as, for example, plastic.

As best shown in FIGS. 1 and 4, the activatable vacuum system includes a rotatable fan 26, an activatable electric motor 27, and a manipulable control 17. As particularly shown in FIG. 4, the rotatable fan 26 and the electric motor 27 are mounted in the inner hollow 32 of the handle 15 such that the electric motor 27 is mechanically connected to the fan 26. In this configuration, the electric motor 27 is able to rotate the fan 26 whenever the motor 27 is activated. The manipulable control 17, in turn, is mounted to the outer surface 16 of the handle 15 and is also electrically connected to both the electric motor 27 and the aforementioned electric power source via electrical control circuitry 28, which is mounted and housed in the handle's inner hollow 32. In general, the manipulable control 17 enables a person to selectively activate and deactivate the electric motor 27 for thereby operating the vacuum system on the device 7. The manipulable control 17 itself may include, for example, a pressable button, a throwable switch, or a turnable dial. In the embodiment depicted in FIGS. 1 through 5, the manipulable control 17 particularly is a button that can simply be pressed by a person's thumb, as further shown in FIG. 6.

To provide sufficient electric power for operating the vacuum system's motor 27 when activated, the electric power source includes one or more batteries that are electrically connected to the vacuum system via the control circuitry 28. In the embodiment depicted in FIG. 4, the electric power source is shown to particularly include three batteries 29A, 29B, and 29C mounted and housed in the handle's inner hollow 32. The batteries themselves may either be standard disposable type batteries or rechargeable type batteries. To facilitate permanent replacement or temporary removal of the batteries, the handle 15 includes a threaded end cap 30, which is unscrewable and thus removable from the handle's main housing.

As shown in FIG. 4, the hold 18 has an accessible collection area 24 defined therein, and the handle 15 further has an open exhaust port 21 defined on its outer surface 16. The hold 18 is removably fastenable onto the handle's exhaust port 21 such that the hold's collection area 24 is in fluid communication with the handle's inner hollow 32. To pass air that is emitted from the handle's exhaust port 21 during operation of the aforementioned vacuum system, the hold 18 is preferably made of material that is permeable by air. Composed of such, the hold 18 itself may simply be, for example, a pliable bag 23. In general, the hold 18 serves to collect any insects or insect remains that are drawn into the intake 20 of the tube 12 when the vacuum system of the portable device 7 is activated.

To operate the portable device 7, a person may take the device 7 in one hand and use that same hand's thumb to manipulate (for example, press) the control 17 on the device's handle 15 so as to switch the device 7 “on.” Upon switching the device 7 on in this manner, electric current from the device's electric power source (i.e., batteries 29A, 29B, and 29C) is thereby communicated to the electric motor 27 of the vacuum system via the electrical control circuitry 28. Once the electric current is successfully communicated to the electric motor 27, the motor 27 is thereby activated, and the motor 27 then rotates the fan 26. As the fan 26 is rotated, outside air is thereby drawn into the intake 20 of the hollow tube 12 and communicated through the tube's conduit 25 to the inner hollow 32 of the handle 15. As the fan 26 continues to rotate, the air communicated to the handle's inner hollow 32 is then expelled from the handle 15 via the handle's exhaust port 21. Upon being expelled from the handle 15, the air then moves into the collection area 24 within the bag 23 (i.e., hold 18) and thereafter passes through the bag's air-permeable material, thereby returning back outside the device 7.

While air is being drawn and circulated through the portable device 7 in the above-described manner, the person may grip and wield the device 7 so as to strike at any annoying or pesky flies, for example, with the swatting surface 10 of the device's spread structure 8. Upon firmly striking the flies with the swatting surface 10, the flies are generally thereby merely stunned because of the spread structure's peripheral padding 11 which prevents the flies from being fully squashed between the device's swatting surface 10 and another surface (for example, a building wall or a dining table). After stunning the flies in this manner, the person may then move the device's intake 20 toward the stunned flies as necessary so as to ultimately draw the flies into the device 7. Once the flies are drawn into the device 7, the flies are then circulated through the tube 12, into the handle's inner hollow 32, out the handle's exhaust port 21, and into the collection area 24 of the bag 23 (i.e., hold 18). If, over time, the bag 23 accumulates a large number of flies and becomes full, the person may then manipulate the control 17 on the device's handle 15 so as to switch the device 7 “off.” After switching the device 7 off, the bag 23 may then be removed from the handle's exhaust port 21 by loosening the fastener 19. Thereafter, the bag 23 may be emptied of its contents (i.e., flies) for ultimate disposal thereof. Once the bag 23 is emptied, the bag 23 may then be refastened to the handle's exhaust port 21 so as to make the device 7 ready for further operation. If, however, the bag 23 becomes excessively soiled or is a disposable type bag, the bag 23 may instead be thrown away and replaced with a new bag.

In summary, utilizing a portable device for swatting and collecting bugs pursuant to the present invention makes the collection and disposal of bugs, insects, flies, and their respective remains easier and less messy.

While the present invention has been described in what is presently considered to be its most practical and preferred embodiment or implementation, it is to be understood that the invention is not to be limited to the particular embodiment disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. A portable device for swatting and collecting bugs, said device comprising:
a spread structure having a designated swatting surface;
a handle having an inner hollow defined therein;
a hollow tube having an open distal end joined to said spread structure and an open proximal end joined to said handle so as to establish fluid communication between said swatting surface of said spread structure and said inner hollow of said handle;
an activatable vacuum system in fluid communication with said inner hollow of said handle;
an electric power source electrically connected to said vacuum system; and
a hold in fluid communication with said inner hollow of said handle;
whereby bugs can be struck with said swatting surface of said spread structure by wielding said handle, and air can be drawn into said open distal end of said hollow tube by activating said vacuum system so as to convey said bugs to said hold.

2. A portable device according to claim 1, wherein said spread structure comprises at least one material selected from the group consisting of metal, plastic, and rubber.

3. A portable device according to claim 1, wherein said spread structure comprises a wire mesh.

4. A portable device according to claim 1, wherein said swatting surface is substantially planar.

5. A portable device according to claim 1, wherein said swatting surface is perforated.

6. A portable device according to claim 1, wherein said spread structure includes raised padding at the periphery of its swatting surface.

7. A portable device according to claim 6, wherein said raised padding comprises at least one material selected from the group consisting of plastic and rubber.

8. A portable device according to claim 1, wherein said handle comprises material that is electrically insulative and substantially shatterproof.

9. A portable device according to claim 1, wherein said handle has a suspension loop on its outer surface.

10. A portable device according to claim 1, wherein said hollow tube is substantially cylindrical.

11. A portable device according to claim 1, wherein said hollow tube comprises a resilient material so as to be flexible.

12. A portable device according to claim 1, wherein said activatable vacuum system includes a rotatable fan, an electric motor mechanically connected to said fan, and a manipulable control electrically connected to said electric motor and said electric power source.

13. A portable device according to claim 12, wherein said rotatable fan and said electric motor are mounted in said inner hollow of said handle.

14. A portable device according to claim 12, wherein said manipulable control is mounted to the outer surface of said handle.

15. A portable device according to claim 1, wherein said electric power source includes at least one battery.

16. A portable device according to claim 15, wherein each said battery is replaceably housed in said inner hollow of said handle.

17. A portable device according to claim 15, wherein each said battery is rechargeable.

18. A portable device according to claim 1, wherein said hold comprises material that is permeable by said air.

19. A portable device according to claim 1, wherein said hold is a bag that comprises pliable material.

20. A portable device according to claim 1, wherein said hold is removably fastened to said handle.
